(19) United States
(12) Patent Application Publication
(10) Pub. No.: US 2022/0230287 A1
(43) Pub. Date: Jul. 21, 2022

(54) INFORMATION PROCESSING DEVICE, INFORMATION PROCESSING SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Chihiro INABA, Tokyo (JP); Hiromi Tonegawa, Kounan-shi (JP); Toshiyuki Hagiya, Shiki-shi (JP)

(73) Assignee: TOYOTA JIDOSHA KABUSHIKI KAISHA, Toyota-shi (JP)

(21) Appl. No.: 17/643,311

(22) Filed: Dec. 8, 2021

(30) Foreign Application Priority Data
Jan. 20, 2021 (JP) 2021-007022

(51) Int. Cl. G06T 5/50; G06T 7/00; G06V 10/74; G06T 7/70; G06T 5/00; G06V 20/58

(52) U.S. Cl. CPC G06T 5/50; G06T 7/0002; G06V 10/761; G06T 7/70; G06T 2207/30252; G06V 20/58; G06T 2207/20221; G06T 2207/30168; G06V 2201/08; G06T 5/005

(57) ABSTRACT

The first processor is configured to acquire captured images that have been captured by plural vehicles and that each of the captured images satisfies plural predetermined conditions including an image capture freshness condition, an image capture condition, and a moving body condition relating to a moving body in the captured image, and also acquire vehicle information including position information corresponding to the respective captured images, and to detect the moving body present in one of the captured images. Then, based on the captured images and the vehicle information, the first processor is configured to, from other of the acquired captured images corresponding to an image capture position of the one captured image in which the moving body has been detected, select another of the captured images having a predetermined similarity level or higher to the one captured image, and to remove the detected moving body from the one captured image, extract an image corresponding to a removed region from the selected other captured image, and merge these images.

### CROSS-REFERENCE TO RELATED APPLICATION

This application is based on and claims priority under 35 USC 119 from Japanese Patent Application No. 2021-007022 filed on Jan. 20, 2021, the disclosure of which is incorporated by reference herein.

### BACKGROUND

### Technical Field

The present disclosure relates to an information processing device, an information processing system, and an information processing program that perform processing to gather and store captured images captured by vehicles so as to enable browsing of the captured images.

### Related Art

Japanese Patent Application Laid-Open (JP-A) No. 2012-129961 proposes an image database construction system including an image database provided with a reception section that receives information transmitted from a terminal, an image determination section that determines whether or not to adopt an image as a most recent image for a particular image capture location based on the information received by the reception section, and an image storage section that stores an image transmitted from the terminal as the most recent image for the image capture location in a case in which determination has been made by the image determination section to adopt the image as the most recent image.

However, the technology disclosed in JP-A No. 2012-129961 is not capable of obtaining an image in which no moving bodies are present in a case in which a background image is hidden by a moving body such as a person or vehicle. There is room for improvement in this respect.

### SUMMARY

The present disclosure provides an information processing device, an information processing system, and an information processing program that are capable of employing an image acquired from a vehicle to generate an image in which a moving body is not present.

An information processing device according to a first aspect includes an acquisition section configured to acquire captured images that have been captured by plural vehicles and that each of the captured images satisfies plural predetermined conditions including an image capture freshness condition, an image capture condition, and a moving body condition relating to a moving body in the captured image, and to also acquire vehicle information including position information corresponding to the respective captured images, a detection section configured to detect the moving body present in one of the captured images acquired by the acquisition section, a selection section configured to, based on the captured images and the vehicle information acquired by the acquisition section, from other of the captured images acquired by the acquisition section and corresponding to an image capture position of the one captured image in which the moving body has been detected by the detection section, select another of the captured images having a predetermined similarity level or higher to the one captured image, and a merging section configured to remove the moving body detected by the detection section from the one captured image, to extract an image corresponding to a removed region from the other captured image selected by the selection section, and to merge these images.

According to the first aspect, the acquisition section acquires the captured images that have been captured by plural vehicles and that each of the captured images satisfies the plural predetermined conditions including the image capture freshness condition, the image capture condition, and the moving body condition relating to the moving body in the captured image. The acquisition section also acquires the vehicle information including the position information corresponding to the respective captured images.

The detection section detects the moving body present in the one captured image acquired by the acquisition section. Based on the captured images and the vehicle information acquired by the acquisition section, from other of the captured images acquired by the acquisition section and corresponding to the image capture position of the one captured image in which the moving body has been detected by the detection section, the selection section selects another of the captured images having a predetermined similarity level or higher to the one captured image.

The merging section removes the moving body detected by the detection section from the one captured image, extracts an image corresponding to the removed region from the other captured image selected by the selection section, and merges these images. Merging the captured images in this manner enables an image in which no moving body is present to be generated using the captured images acquired by the respective vehicles.

Configuration may be made wherein the acquisition section gives a score for the image capture freshness condition, the image capture condition, and the moving body condition, and acquires any of the captured images for which the score is a predetermined threshold or higher.

This enables score-based evaluation of the image capture freshness condition, the image capture condition, and the moving body condition, enabling easy acquisition of captured images that have been recently captured under favorable image capture conditions, and in which any moving bodies in the captured image occupy a small number of pixels.

Configuration may be made wherein the score is computed such that a score for the image capture freshness condition becomes higher the more recent an image capture date and time are, a score for the image capture condition that becomes higher as a brightness level approaches a predetermined brightness level suited to conditions at the time of image capture and the slower a vehicle speed is, and a score for the moving body condition becomes higher the fewer pixels that are occupied by the moving body in the captured image. This approach enables the image capture freshness condition, the image capture condition, and the moving body condition to be evaluated based on a single score.

Configuration may be made wherein the acquisition section performs acquisition a predetermined number of times within a predetermined time period. This enables appropriate captured images to be obtained from plural vehicles that have traveled past a target point during the predetermined time period.

Configuration may be made wherein the acquisition section changes the threshold and acquires the captured images so as to perform acquisition a predetermined number of times within a predetermined time period. This enables acquisition of the requisite number of captured images over the course of the predetermined time period.

Configuration may be made wherein the selection section prioritizes selection of the captured image for at least one case of a captured image captured by a same or a similar vehicle type, or a captured image captured at a same or a similar timing. This enables selection of a captured image having a higher similarity level than in a case in which captured images from different vehicle types or captured images taken at different timings are selected.

Configuration may be made wherein the selection section prioritizes selection of the captured image in a case in which a position of a vanishing point in the captured image is within a predetermined range. This enables selection of a captured image with a higher similarity level than in a case in which a captured image having a completely different vanishing point position is selected.

Configuration may be made wherein the selection section extracts a predetermined tracking region from the captured images, and selects as the other captured image a captured image having a feature value with a predetermined similarity level or higher to a feature value of the one captured image for the tracking region. This enables an appropriate captured image to be selected, while reducing the processing load. In such cases, the tracking regions may be configured by a region other than at least one region of a region in which an own-vehicle is captured in the captured image, or a region in which a vehicle traveling alongside is captured in the captured image.

An information processing system may be configured including the information processing device described above, and an onboard unit that is installed to a vehicle, and that includes an image capture section configured to capture a vehicle periphery to generate the captured images and a detection section configured to detect vehicle information including position information of the vehicle at a time of image capture.

Alternatively, an information processing program may be configured to cause a computer to function as the respective sections of the information processing device described above.

As described above, the present disclosure is capable of providing an information processing device, an information processing system, and an information processing program that are capable of employing an image acquired from a vehicle to generate an image in which a moving body is not present.

### BRIEF DESCRIPTION OF THE DRAWINGS

Exemplary embodiments of the present invention will be described in detail based on the following figures, wherein:

FIG. 1 is a diagram illustrating a schematic configuration of an information processing system according to an exemplary embodiment;

FIG. 2 is a block diagram illustrating configurations of an onboard unit and a central server of an information processing system according to an exemplary embodiment;

FIG. 3 is a block diagram illustrating configurations of a control section of an onboard unit and a central processing section of a central server in an information processing system according to an exemplary embodiment;

FIG. 4 is a diagram to explain a generation method for a common image by a common image generation section;

FIG. 5 is a flowchart illustrating an example of a flow of image capture processing performed by an onboard unit of an information processing system according to an exemplary embodiment;

FIG. 6 is a flowchart illustrating an example of a flow of processing to gather captured images from onboard units performed by a central server of an information processing system according to an exemplary embodiment;

FIG. 7 is a flowchart illustrating an example of a flow of processing performed by an onboard unit to transmit a captured image following a request from a central server in an information processing system according to an exemplary embodiment;

FIG. 8 is a flowchart illustrating an example of a flow of processing to generate a common image performed by a common image generation section of a central server in an information processing system according to an exemplary embodiment;

FIG. 9 is a flowchart illustrating a specific example of a flow of processing during video frame matching processing; and

FIG. 10 is a diagram to explain examples of a non-tracking region.

### DETAILED DESCRIPTION

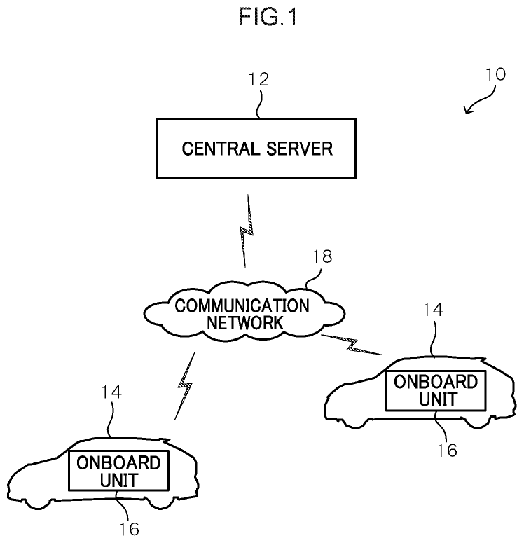

Detailed explanation follows regarding an example of an exemplary embodiment of the present disclosure, with reference to the drawings. FIG. 1 is a diagram illustrating a schematic configuration of an information processing system according to the present exemplary embodiment.

An information processing system 10 according to the present exemplary embodiment includes onboard units 16 installed to respective vehicles 14 and a central server 12 serving as an information processing device, connected together over a communication network 18. In the present exemplary embodiment, onboard units 16 installed to plural vehicles 14 are capable of communicating with the central server 12.

In the information processing system 10 according to the present exemplary embodiment, the central server 12 performs processing to gather various data stored in the plural onboard units 16. Examples of the various data stored in the onboard units 16 include image information expressing captured images obtained by image capture and vehicle information expressing states of the respective vehicles 14. In the present exemplary embodiment, the central server 12 employs the captured images gathered from the onboard units 16 in processing to generate captured images in which moving bodies such as vehicles 14 and pedestrians do not appear.

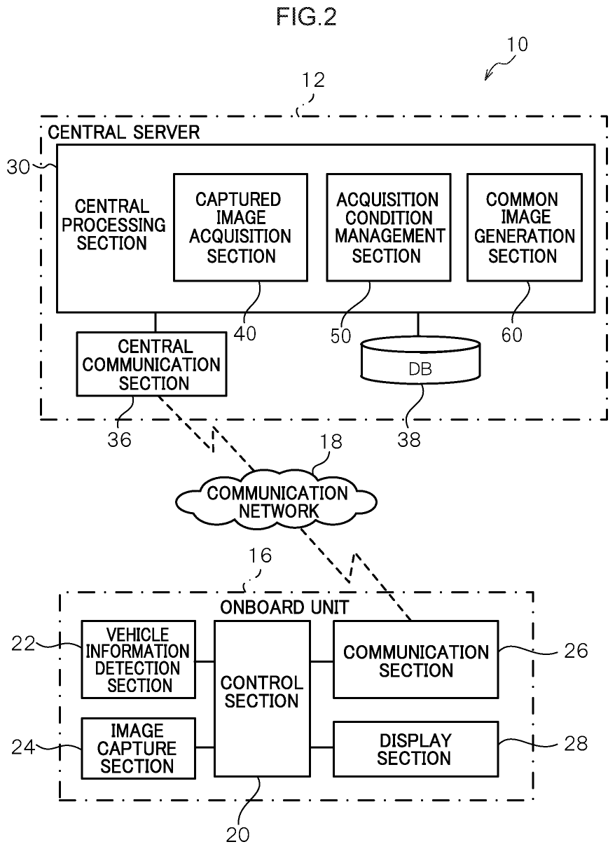

Detailed explanation follows regarding the configuration of respective sections of the information processing system 10 according to the present exemplary embodiment. FIG. 2 is a block diagram illustrating configuration of the onboard units 16 and the central server 12 of the information processing system 10 according to the present exemplary embodiment.

Each of the onboard units 16 includes a control section 20, a vehicle information detection section 22, an image capture section 24, a communication section 26, and a display section 28.

The vehicle information detection section 22 detects vehicle information relating to the corresponding vehicle 14, including at least position information for the vehicle 14. Examples of the vehicle information detected include the position information, a vehicle speed, acceleration, steering angle, accelerator pedal position, distances to obstacles peripheral to the vehicle, a route, and the like for the vehicle 14. Specifically, the vehicle information detection section 22 may employ plural types of sensors and devices to acquire information expressing a situation in the vehicle 14 and its peripheral environment. Examples of such sensors and devices include sensors installed to the vehicle 14, such as a vehicle speed sensor and an acceleration sensor, as well as a global navigation satellite system (GNSS) device, an onboard communication device, a navigation system, a radar system, and so on. A GNSS device measures the position of the own-vehicle 14 by receiving GNSS signals from plural GNSS satellites. An onboard communication device is a communication device that communicates through the communication section 26 using at least one of vehicle-to-vehicle communication with other vehicles 14 or road-to-vehicle communication with roadside equipment. A navigation system includes a map information storage section that stores map information, and performs processing to display the position of the own-vehicle 14 on a map and guide the own-vehicle 14 on a route to a destination based on the position information obtained by the GNSS device and the map information stored in the map information storage section. A radar system includes plural radar units with different detection ranges to one another, and is used to detect objects such as pedestrians and other vehicles 14 present peripheral to the vehicle 14 and also to acquire relative positions and relative speeds of such detected objects with respect to the vehicle 14. Such a radar system includes a built-in processor to process detection results for peripheral objects. This processor eliminates noise and roadside objects such as guardrails from monitoring targets based on changes in the relative positions and relative speeds of the respective objects included in the several most recent detection results, and tracks and monitors pedestrians, other vehicles 14, and the like as monitoring targets. The radar system also outputs information relating to the relative positions, relative speeds, and the like of the respective monitoring targets.

The image capture section 24 is installed to the vehicle 14, and images the vehicle periphery, for example ahead of the vehicle 14, in order to generate video image data as image data expressing captured images in video images. For example, a camera of a drive recorder or the like may be applied as the image capture section 24. Note that the image capture section 24 may also image the vehicle periphery to at least one of the sides or the rear of the vehicle 14. The image capture section 24 may also image a vehicle cabin interior. In the present exemplary embodiment, the image information generated by the image capture section 24 is initially saved in the control section 20, although such image information may, for example, be uploaded to the central server 12 without being saved.

The communication section 26 establishes communication with the central server 12 over the communication network 18, and exchanges various data such as the image information obtained through image capture by the image capture section 24 and the vehicle information detected by the vehicle information detection section 22 with the central server 12. Note that the communication section 26 may also be configured capable of establishing inter-vehicle communication in order to perform vehicle-to-vehicle communication.

The display section 28 displays various information in order to provide the various information to an occupant. For example, the display section 28 may display information provided from the central server 12.

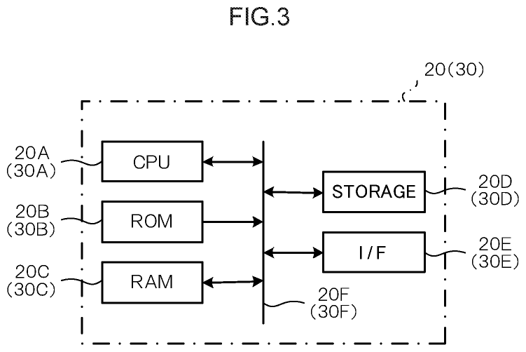

As illustrated in FIG. 3, the control section 20 is configured by a generic microcomputer including a central processing unit (CPU) 20A, read only memory (ROM) 20B, random access memory (RAM) 20C, storage 20D, an interface (I/F) 20E, a bus 20F, and the like.

The CPU 20A of the control section 20 serves as a second processor, and expands and executes a program held in the ROM 20B, serving as a second memory, in the RAM 20C in order to perform processing to upload the various information to the central server 12 and the like. Note that a program may be expanded into the RAM 20C from the storage 20D, serving as a second memory.

Meanwhile, as illustrated in FIG. 2, the central server 12 includes a central processing section 30, a central communication section 36, and a database (DB) 38.

As illustrated in FIG. 3, the central processing section 30 is configured by a generic microcomputer including a CPU 30A, ROM 30B, RAM 30C, storage 30D, an interface (I/F) 30E, a bus 30F, and the like. Note that a graphics processing unit (GPU) may be applied as the CPU 30A.

The CPU 30A of the central processing section 30 serves as a first processor, and expands and executes a program held in the ROM 30B or the storage 30D, either of which may serve as a first memory, in the RAM 30C in order to function as a captured image acquisition section 40, an acquisition condition management section 50, and a common image generation section 60. Note that the captured image acquisition section 40 and the acquisition condition management section 50 both correspond to an acquisition section. The common image generation section 60 corresponds to a detection section, a selection section, and a merging section, and will be described in detail later.

From the captured images captured by the plural vehicles 14, the captured image acquisition section 40 acquires and collects in the DB 38 captured images and vehicle information, including position information corresponding to the captured images, that conform to conditions set by the acquisition condition management section 50. The captured image acquisition section 40 may perform acquisition a predetermined number of times within a predetermined time period. This enables appropriate captured images to be obtained from plural vehicles that have traveled past a target point during the predetermined time period.

The acquisition condition management section 50 manages acquisition conditions for the captured images acquired from the plural vehicles 14. Specifically, the acquisition condition management section 50 sets conditions for acquisition of captured images from the vehicles 14 so as to acquire captured images that satisfy plural predetermined conditions, including an image capture freshness condition, image capture conditions, and a moving body condition relating to a moving body present in the captured image. For example, the acquisition condition management section 50 manages so as to acquire captured images that are recent captured images conforming to the image capture freshness condition, are also captured images captured under favorable image capture conditions (for example during the daytime, in good weather, and at low speed) conforming to the image capture conditions, and are also captured images in which moving bodies such as pedestrians or vehicles 14 occupy a small number of pixels conforming to the moving body condition. The acquisition condition management section 50 scores for the plural conditions including the image capture freshness condition, the image capture conditions, and the moving body condition, and the captured image acquisition section 40 performs management so as to acquire captured images having a score that meets a predetermined threshold or higher. This enables score-based evaluation of the plural conditions, enabling easy acquisition of captured images that have been recently captured under favorable image capture conditions, and in which any moving bodies in the captured image occupy a small number of pixels. For example, the score for the image capture freshness condition computed to give a higher score the more recent the image capture date and time are, the image capture condition score is computed to give a higher score the closer a brightness level to a predetermined brightness level suited to the conditions at the time of image capture and the slower the vehicle speed, and the moving body condition score is computed to give a higher score the fewer pixels occupied by a moving body in the captured image. This approach enables the image capture freshness condition, the image capture condition, and the moving body condition to be evaluated based on a single score. Note that the scores for the plural conditions including the image capture freshness condition, the image capture condition, and the moving body condition may, for example, be scores computed using the vehicle information acquired together with the captured images from the onboard units 16.

The common image generation section 60 detects for moving bodies present in one captured image. Then, based on the captured images and vehicle information collected in the DB 38, the common image generation section 60 selects another captured image having a predetermined similarity level or higher to the one captured image from other captured images collected in the DB 38 having an image capture position corresponding to that of the captured image in which a moving body has been detected. Namely, the common image generation section 60 selects a captured image that is similar to the one captured image in its own right and that also has the same or a similar image capture position. Specifically, the common image generation section 60 selects captured images using video frame matching processing. The video frame matching processing is used to extract captured images captured within a specific range (for example 10 m toward the front and rear) of a comparison target captured image from captured images captured by a vehicle 14 traveling past the same point according to the position information. Feature values (specifically, local feature values of plural locations, configured by a collection of plural local feature value vectors) are calculated, and matches for the feature values are ascertained in a predetermined tracking region in order to select a matching result with a high similarity level. Note that the predetermined tracking region is, for example, a region other than a region in which the bonnet or the like of the own-vehicle 14 appears. In a case in which the other captured image with an image capture position corresponding to that of the one captured image in which a moving body has been detected is selected from captured images from other vehicles 14, selection of a captured image that is at least one of a captured image captured by a same or a similar vehicle type or a captured image captured at a same or a similar timing may be prioritized. This enables selection of a captured image having a higher similarity level than in a case in which captured images from different vehicle types or captured images taken at different timings are selected. Note that when selecting a captured image having a predetermined similarity level or higher, the vanishing point may be used to prioritize selection of images having a vanishing point position within a specific range (for example when positional misalignment of the vanishing point is within a predetermined range, for example 10 to 20 pixels, with respect to the captured image). This enables selection of a captured image with a higher similarity level than in a case in which a captured image having a completely different vanishing point position is selected. Alternatively, when performing video frame matching processing, matching may be performed after correcting misalignment between captured images using the vanishing point position. Alternatively, in the case of captured images that cannot be obtained from the same viewpoint, for example the same traffic lane, lateral correction may be carried out before performing matching.

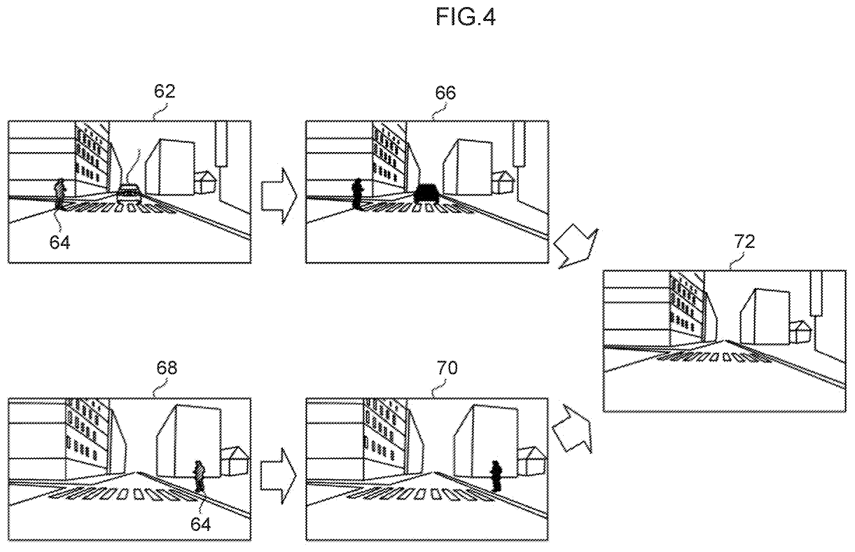

The common image generation section 60 also performs removal processing to identify a moving body in the one captured image and remove the moving body from the one captured image, and merge processing to extract from the other captured image selected using the video frame matching processing an image corresponding to a region from which the moving body has been removed, and merging the respective images together. An image generated as a result of the removal processing and the merge processing is then held in the DB 38 as a common image. For example, as illustrated in FIG. 4, in a case in which a single leading vehicle 14 and a single pedestrian 64 are present in a given captured image 62 among captured images that have been uploaded, a post-removal captured image 66 is generated in which the pedestrian 64 and the vehicle 14 have been removed from the given captured image 62. In a case in which a single pedestrian 64 is present in a selected captured image 68 that has been selected by the video frame matching processing, a post-removal selected captured image 70 is generated in which the pedestrian 64 has been removed from the selected captured image 68. Images corresponding to locations in the post-removal captured image 66 from which the pedestrian 64 and the vehicle 14 have been removed are then extracted from the post-removal selected captured image 70 and merged with the post-removal captured image 66 so as to generate a common image 72. When extracting from the post-removal selected captured image 70 and merging with the post-removal captured image 66, abstract features are extracted and conditions relating to the brightness level of the image, such as lighting conditions, are adjusted when merging. This enables the common image 72, in which neither the vehicle 14 nor the pedestrian 64 are present, to be generated and collected in the DB 38. Note that FIG. 4 is a diagram to explain a generation method of a common image by the common image generation section 60. Moreover, regarding the removal of moving bodies and merging, although explanation follows regarding a case in which removal of moving bodies and merging are performed using shapes corresponding to those of the moving bodies, configuration may be made such that bounding boxes containing the identified moving bodies are removed and regions corresponding to the bounding boxes are then extracted from the captured image from another vehicle 14 and merged. Moreover, when removing a shape corresponding to a moving body, although the present exemplary embodiment envisages removal of a region in which a margin is provided around the moving body to give a shape larger than that of the moving body, alternatively a shape fitted to the outline of the moving body may be removed instead.

The central communication section 36 establishes communication with the onboard units 16 over the communication network 18, and exchanges information such as image information and vehicle information with the onboard units 16.

The DB 38 requests information transmission from the respective vehicles 14 and collects the resulting data acquired from the respective vehicles 14. The DB 38 also collects the common images 72 generated by the common image generation section 60. Examples of the data acquired from the vehicles 14 and collected include image capture information expressing the captured images captured by the image capture sections 24 of the respective vehicles 14, vehicle information detected by the vehicle information detection sections 22 of the respective vehicles 14, and the like.

Note that imagery employed in map generation and the like preferably employs captured images captured under predetermined favorable image capture conditions, for example recent imagery that was captured during the day, in good weather, and at a low travel speed.

In the present exemplary embodiment, in order to generate the common images 72 from which moving bodies such as leading vehicles 14 and pedestrians 64 have been removed, it is desirable to acquire captured images in which moving bodies are not present wherever possible. Accordingly, in addition to the image capture conditions listed above, acquisition conditions may also be managed to avoid, as far as possible, uploading captured images when conditions such as the following apply. Note that since the aim is only to “avoid as far as possible”, if for example the only captured images available do not satisfy a condition of having being captured within the past month, such captured images may still be employed in common image generation despite not meeting this condition.

As an example of an acquisition condition, captured images may be avoided in a case in which a pedestrian 64 has been detected based on pedestrian detection information detected using the functionality of an advanced driver-assistance system (ADAS) that includes functionality to detect and avoid collisions with such pedestrians 64.

As another example of an acquisition condition, similarly, captured images captured when traveling behind a leading vehicle may be avoided, in particular when an inter-vehicle distance is short or when captured in heavy traffic. This condition may take into account not only an own-vehicle traffic lane but also neighboring traffic lanes.

As another example of an acquisition condition, density information regarding pedestrians 64 and vehicles 14 may be acquired from a separate database (for example a mobile spatial statistics database) in order to avoid captured images from regions with a high density of pedestrians 64 and/or vehicles 14.

As another example of an acquisition condition, captured images may be avoided before and after slips observed based on vehicle information relating to anti-lock brake system (ABS) actuation, in order to avoid captured images captured following rain or in icy conditions.

As another example of an acquisition condition, captured images captured when traveling in a right hand side traffic lane on left hand drive roads, when changing lane, or the like may also be avoided. In other words, captured images captured when traveling in the traffic lane closest to the sidewalk and not changing lanes are uploaded.

As an example, upload determination by the acquisition condition management section 50 employing acquisition conditions such as those described above may be made offline. In such cases, upload determination is performed using combined scores for the plural conditions described above. The combined scores for the plural conditions may, for example, be computed using weighted summing or the like.

Specifically, initially only vehicle information, this having a smaller data size than the captured images, is uploaded. Appropriate captured images are then extracted and uploaded from plural vehicles that have traveled past a target point during a given time period.

Since each of the vehicles 14 has finite storage, it is necessary to perform upload determination within a certain time period (threshold update: for example one week) that is shorter than an update frequency of the common images in the DB 38 (for example one month). Accordingly, a threshold is decided based on recent results such that upload instructions are given in a manner that will achieve an appropriate number of uploads. Namely, the threshold may be changed and upload instructions given such that acquisition is performed a predetermined number of times over the course of a predetermined time period. This enables acquisition of the requisite number of captured images over the course of the predetermined time period. When changing the threshold, the threshold is changed based on results of past travel. For example, in a case in which acquisition of a single captured image over the course of one month is desired, if it is known based on scores from a preceding time period that four captured images having scores of 1, 2, 4, and 8 are likely be acquirable during this time period, the threshold for upload determination may be set to around 6. Moreover, if an upload exceeding the threshold has already been acquired within a given month, the threshold may be raised for the time period of the next threshold update (for example the next one week), whereas the threshold may be lowered if it does not seem likely that the requisite uploads will be achieved within the time period based on the current threshold. Note that the threshold update may set different thresholds for each street or each district, since the level of congestion of vehicles 14 and pedestrians will differ between streets and districts.

Next, explanation follows regarding specific processing performed by the respective sections of the information processing system 10 in the present exemplary embodiment configured as described above.

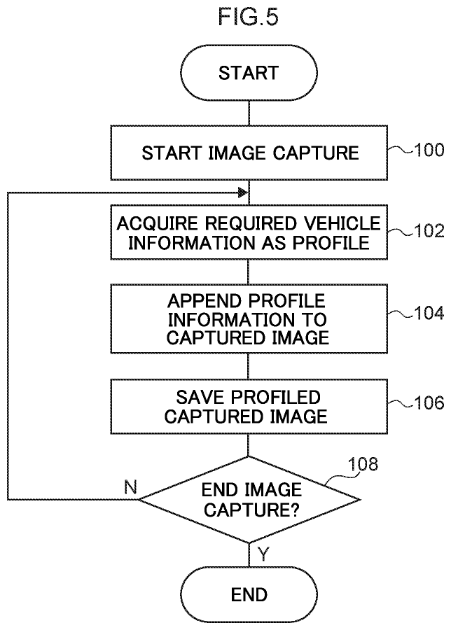

First, explanation follows regarding specific processing performed in order to capture the vehicle periphery with the image capture section 24 of the onboard unit 16. FIG. 5 is a flowchart illustrating an example of a flow of image capture processing performed by the onboard units 16 of the information processing system 10 according to the present exemplary embodiment. Note that as an example, the processing illustrated in FIG. 5 is initiated when the onboard unit 16 is started up when a non-illustrated ignition switch or the like of the corresponding vehicle 14 is switched ON.

At step 100, the CPU 20A starts vehicle periphery image capture, and processing transitions to step 102. Namely, the image capture section 24 starts image capture of the vehicle periphery.

At step 102, the CPU 20A acquires the required vehicle information as a captured image profile, and processing transitions to step 104. This acquisition of vehicle information is performed by acquiring detection results of the vehicle information detection section 22. Information regarding the weather at the time of image capture as well as image capture conditions and congestion information may also be acquired from an external server.

At step 104, the CPU 20A appends the acquired profile information to the captured image, and processing transitions to step 106.

At step 106, the CPU 20A saves the profiled captured image in the storage 20D, and processing transitions to step 108. The profiled captured image is saved such that the captured image is saved in association with the profile information, with the profile information being saved so as to be capable of being read independently of the corresponding captured image.

At step 108, the CPU 20A determines whether or not to end image capture. This determination is, for example, determination as to whether or not an instruction has been given to switch the non-illustrated ignition switch OFF. In a case in which this determination is negative, processing returns to step 102 to continue image capture and repeat the processing described above. In a case in which determination is affirmative the image capture processing routine is ended.

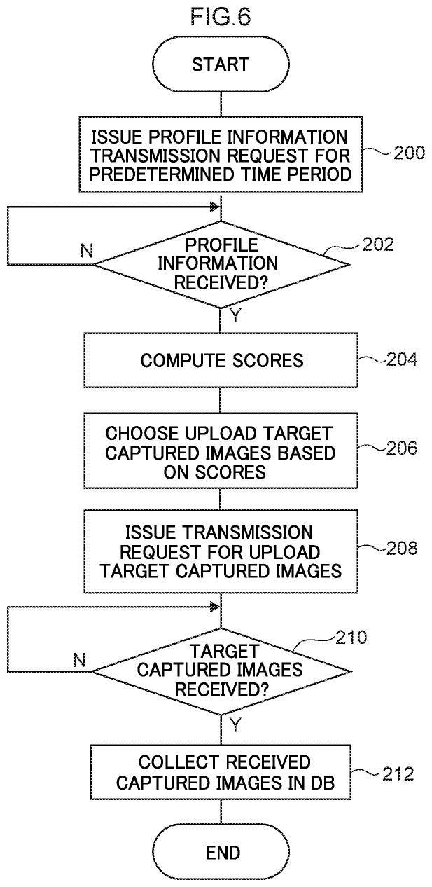

Next, explanation follows regarding specific processing performed by the central server 12 when gathering captured images from the onboard units 16. FIG. 6 is a flowchart illustrating an example of a flow of processing performed by the central server 12 of the information processing system 10 according to the present exemplary embodiment in order to gather captured images from the onboard units 16. Note that as described above, the processing in FIG. 6 is initiated according to a regular cycle with a shorter time period (for example one week) than the predetermined update frequency of the common images 72 (for example one month).

At step 200, the CPU 30A issues a transmission request for profile information corresponding to a predetermined time period (for example one week) to the respective onboard units 16, and processing transitions to step 202. Namely, the acquisition condition management section 50 issues an acquisition request for profile information corresponding to the predetermined time period from the profile information saved in the storage 20D of the respective onboard units 16.

At step 202, the CPU 30A determines whether or not profile information has been received. This determination is determination as to whether or not the requested profile information has been received, and the CPU 30A stands by until determination is affirmative before processing transitions to step 204.

At step 204, the CPU 30A computes a score by scoring the plural acquisition conditions relating to captured image acquisition, and processing transitions to step 206. For example, as described above, weighted averages or the like are employed to compute a score for each captured image corresponding to the profile information.

At step 206, the CPU 30A chooses captured images as upload targets based on their scores, and processing transitions to step 208. For example, captured images having a score that meets a predetermined threshold or higher are chosen as the upload targets.

At step 208, the CPU 30A issues a transmission request for the upload target captured images to the onboard units 16, and processing transitions to step 210. For example, the acquisition condition management section 50 outputs to the onboard units 16 a transmission request for captured images having a computed score meeting the predetermined threshold or higher.

At step S210, the CPU 30A determines whether or not a target captured image has been received. The CPU 30A stands by until determination is affirmative before processing transitions to step 212.

At step 212, the CPU 30A sequentially collects the received captured images in the DB 38, and then ends the captured image gathering processing routine.

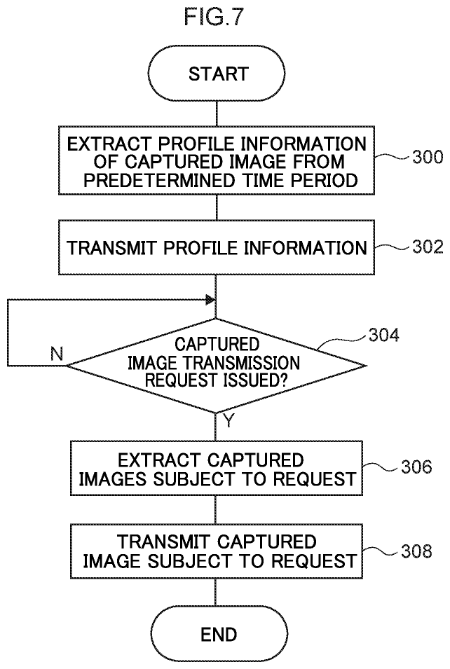

Next, explanation follows regarding specific processing performed by the onboard unit 16 when transmitting captured images following a request from the central server 12. FIG. 7 is a flowchart illustrating an example of a flow of processing performed by the onboard unit 16 of the information processing system 10 according to the present exemplary embodiment in order to transmit captured images following a request from the central server 12. Note that the processing in FIG. 7 is initiated on receipt of a profile information transmission request from the central server 12.

At step 300, the CPU 20A extracts from the storage 20D the profile information of captured images captured over the course of the predetermined time period, and processing transitions to step 302.

At step 302, the CPU 20A transmits the extracted profile information to the central server 12, and processing transitions to step 304.

At step 304, the CPU 20A determines whether or not a transmission request for captured images has been issued from the central server 12. This determination is determination as to whether or not a transmission request for captured images has been issued at step 208 described above. The CPU 20A stands by until determination is affirmative before processing transitions to step 306.

At step 306, the CPU 20A extracts from the storage 20D any captured images subject to the request, and processing transitions to step 308.

At step 308, the CPU 20A transmits the captured images subject to the request to the central server 12, and the captured image transmission processing routine is ended.

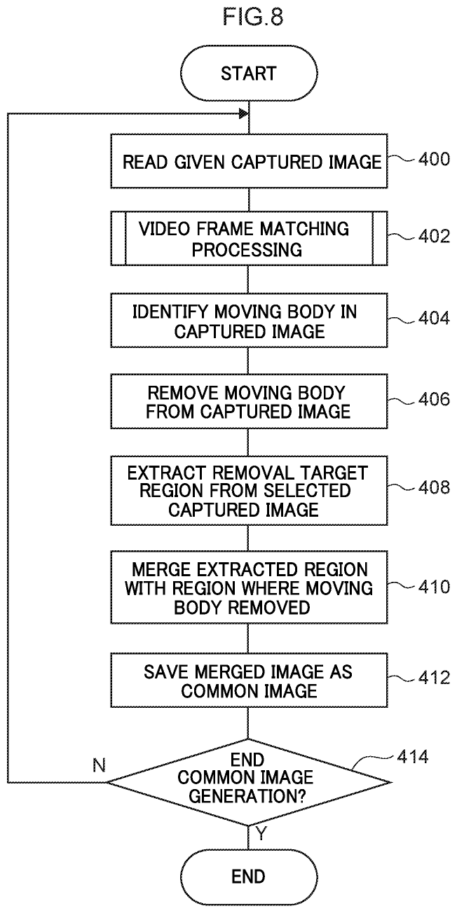

Next, explanation follows regarding specific processing performed by the central server 12 in order to generate the common image 72. FIG. 8 is a flowchart illustrating an example of a flow of processing performed by the common image generation section 60 of the central server 12 of the information processing system 10 according to the present exemplary embodiment in order to generate a common image. The processing of FIG. 8 is initiated according to a regular cycle based on the predetermined update frequency of the common images 72.

At step 400, the CPU 30A reads a given captured image 62 from the captured images collected in the DB 38 over a predetermined time period, and processing transitions to step 402.

At step 402, the CPU 30A performs video frame matching processing, and processing transitions to step 404. In the video frame matching processing, for example captured images from a specific range (for example 10 m toward the front and rear) of a comparison target captured image of the captured images captured by vehicles 14 traveling past the same point are extracted, and respective local feature values are calculated to ascertain matches between the local feature values in the tracking regions in order to select a captured image having a high similarity level in the matching results as the selected captured image 68. Ascertaining matches between the local feature values in the respective tracking regions in this manner enables an appropriate captured image to be selected, while reducing the processing load. Note that the video frame matching processing corresponds to that of a selection section, and this processing will be described in detail later. Moreover, as described above, the tracking region is a region other than a region in which the bonnet or the like of the own-vehicle 14 appears, although there is no limitation thereto. For example, a region other than a region in which at least one of the own-vehicle 14 or a peripheral moving body appears in the captured image may be adopted as a predetermined tracking region.

At step 404, the CPU 30A identifies moving bodies in the captured images, and processing transitions to step S406. For example, deep learning using technology such as semantic segmentation, YOLOv4, or the like is employed to identify moving bodies such as pedestrians 64 and vehicles 14. Moving bodies are identified in both the given captured image 62 and the selected captured image 68 extracted by the video frame matching processing. Note that the processing of step 404 corresponds to that of a detection section.

At step 406, the CPU 30A removes the moving bodies in the captured images from the given captured image 62 and the selected captured image 68 respectively, and processing transitions to step 408.

At step 408, the CPU 30A extracts from the selected captured image 68 selected by the video frame matching processing a region corresponding to a removal target, and processing transitions to step 410. Note that although explanation has been simplified, it is assumed that the selected captured image 68 selected either contains no moving body, or a moving body that is present is at a different position to the moving body in the given captured image 62, and it is also assumed that the region of the given captured image 62 from which the moving body has been removed may be supplemented using the selected captured image 68.

At step 410, the CPU 30A merges the region extracted from the selected captured image 68 with the region of the given captured image 62 from which the moving body has been removed, and processing transitions to step 412. Note that the processing of steps 406 to 410 corresponds to that of a merging section.

At step 412, the CPU 30A saves the merged image in the DB 38 as a common image 72, and processing transitions to step 414.

At step 414, the CPU 30A determines whether or not to end generation of the common images 72. This determination is determination as to whether or not the above processing regarding captured images captured within the predetermined time period has been completed. Processing returns to step 400 in a case in which determination is negative, and the processing described above is repeated with another captured image as the given captured image 62. The processing routine of the common image generation section 60 is ended in a case in which determination is affirmative at step 414.

Generating the common images 72 in this manner enables captured images in which no moving bodies are present to be generated using the captured images acquired from the vehicles 14.

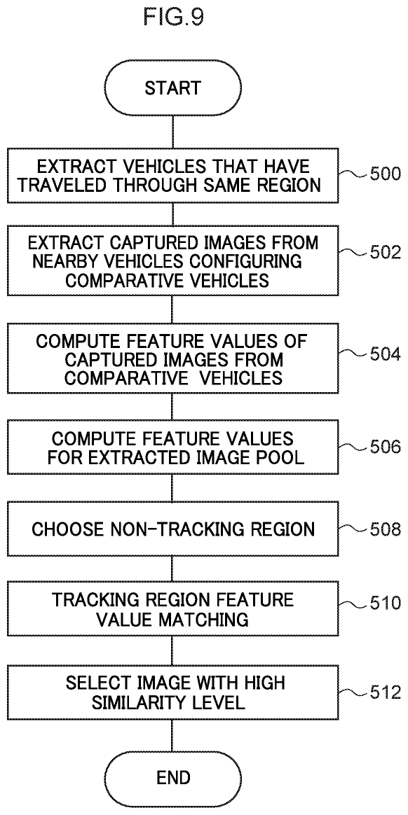

Next, explanation follows regarding the video frame matching processing mentioned above. FIG. 9 is a flowchart illustrating an example of a specific flow of processing of the video frame matching processing.

At step 500, the CPU 30A extracts vehicles 14 that have traveled through the same region, and processing transitions to step 502. For example, vehicles 14 that have traveled through the same region are extracted based on the position information included in the vehicle information.

At step 502, the CPU 30A extracts captured images from nearby vehicles configuring comparative vehicles, and processing transitions to step 504. Namely, the CPU 30A extracts captured images captured by vehicles 14 near to the vehicle 14 that captured a given captured image as a candidate pool for the selected captured image 68.

At step 504, the CPU 30A computes feature values of the captured images from the comparative vehicles, and processing transitions to step 506. Note that the feature values are a collection of plural local feature value vectors, and such local feature values are computed for plural locations.

At step 506, the CPU 30A computes feature values for an extracted image pool, and processing transitions to step 508. Namely, respective local feature values are computed for each captured image in the candidate pool for the selected captured image 68.

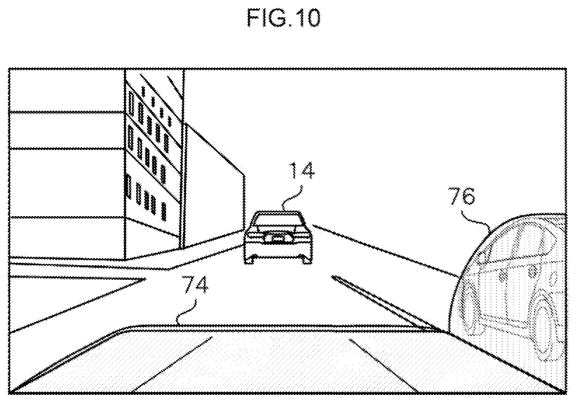

At step 508, the CPU 30A chooses a non-tracking region, and processing transitions to step 510. Examples of the non-tracking region include at least one region of an own-vehicle region 74 in which the hood or the like of the own-vehicle 14 appears in the captured image, or a neighboring vehicle region 76 in which a vehicle 14 is traveling alongside the own-vehicle 14, as illustrated in FIG. 10. The non-tracking region is, for example, ascertained using semantic segmentation.

At step 510, the CPU 30A finds feature value matches for the tracking region outside the non-tracking region, and processing transitions to step 512. Setting the non-tracking region and finding matches using feature values (specifically, local feature values for plural locations, configured by a collection of plural local feature value vectors) enables the processing load to be reduced in comparison to cases in which a non-tracking region is not set. Note that configuration may be made such that step 508 is omitted and matches are found for local feature values without setting non-tracking regions.

At step 512, the CPU 30A selects an image with a high similarity level based on the feature value matching results as the selected captured image 68, and the processing routine is ended.

By performing video frame matching processing in this manner, the requisite selected captured image 68 is selected in order to supplement the region from which a moving body has been removed from the given captured image 62, thereby enabling generation of a common image 72 in which no moving body is present.

Note that in the exemplary embodiment described above, explanation has been given in which the respective functionality of the captured image acquisition section 40, the acquisition condition management section 50, and the common image generation section 60 is implemented by functionality of the single central server 12. However, there is no limitation thereto, and the respective functionality may be distributed between plural servers.

In the exemplary embodiment described above, the central server 12 requests and acquires upload target images. However, there is no limitation thereto, and configuration may be made such that scores are computed on the onboard unit 16 side and captured images that meet a threshold or higher are then uploaded to the central server 12.

Moreover, in the exemplary embodiment described above, an example has been described in which a removal target region is extracted from a single captured image and merged when a moving body is removed from a captured image and the region from which the moving body has been removed is then supplemented using another captured image. However, there is no limitation thereto. For example, configuration may be made such that plural captured images are employed to generate an image corresponding to a removal target region, and this generated image is then merged with the region from which the moving body has been removed from the captured image.

Although explanation has been given in the above exemplary embodiment in which the respective processing executed by the central server 12 and the onboard unit 16 is software processing implemented by executing a program, there is no limitation thereto. For example, the respective processing may be implemented by hardware processing employing an application specific integrated circuit (ASIC), a field-programmable gate array (FPGA), or the like. Alternatively, the respective processing may be implemented by a combination of both software processing and hardware processing. In a case in which software processing is employed, a program may be circulated stored on various non-transitory storage media. Although explanation has been given regarding an example in which the CPU 20A and the CPU 30A serve as processors that execute software processing, there is no limitation thereto. For example, a GPU, ASIC, FPGA, or programmable logic device (PLD) may be applied as such processors.

The present disclosure is not limited to the foregoing description, and obviously various other modifications may be implemented within a range not departing from the spirit of the present disclosure.

What is claimed is:

1. An information processing device comprising:
a first memory; and
a first processor coupled to the first memory, the first processor being configured to:
acquire captured images that have been captured by a plurality of vehicles, each of the captured images satisfying a plurality of predetermined conditions including an image capture freshness condition, an image capture condition, and a moving body condition relating to a moving body in the captured image, and also acquire vehicle information including position information corresponding to the respective captured images;
detect the moving body present in one of the captured images;
based on the captured images and the vehicle information, from other of the acquired captured images corresponding to an image capture position of the one captured image in which the moving body has been detected, select another of the captured images having a predetermined similarity level or higher to the one captured image; and
remove the detected moving body from the one captured image, extract an image corresponding to a removed region from the selected other captured image, and merge these images.

2. The information processing device of claim 1, wherein the first processor is further configured to give a score for the image capture freshness condition, the image capture condition, and the moving body condition, and acquire any of the captured images for which the score is a predetermined threshold or higher.

3. The information processing device of claim 2, wherein the first processor is further configured to compute the score such that a score for the image capture freshness condition becomes higher the more recent an image capture date and time are, a score for the image capture condition becomes higher as a brightness level approaches a predetermined brightness level suited to conditions at the time of image capture and the slower a vehicle speed is, and a score for the moving body condition becomes higher the fewer pixels that are occupied by the moving body in the captured image.

4. The information processing device of claim 1, wherein the first processor is further configured to perform acquisition a predetermined number of times within a predetermined time period.

5. The information processing device of claim 2, wherein the first processor is further configured to change the threshold and acquire the captured images so as to perform acquisition a predetermined number of times within a predetermined time period.

6. The information processing device of claim 1, wherein the first processor is further configured to prioritize selection of the captured image for at least one case of a captured image captured by a same or a similar vehicle type, or a captured image captured at a same or a similar timing.

7. The information processing device of claim 1, wherein the first processor is further configured to prioritize selection of the captured image in a case in which a position of a vanishing point in the captured image is within a predetermined range.

8. The information processing device of claim 1, wherein the first processor is further configured to extract a predetermined tracking region from the captured images, and to select as the other captured image a captured image having a feature value with a predetermined similarity level or higher to a feature value of the one captured image for the tracking region.

9. The information processing device of claim 8, wherein configuration is made such that the tracking region is a region in the captured image other than a region in which at least one of an own-vehicle or a peripheral moving body are captured.

10. An information processing system comprising:
the information processing device of claim 1; and
an onboard unit that is installed to a vehicle, and that includes a second memory and a second processor coupled to the second memory, the second processor being configured to, either in addition to the first processor or instead of the first processor,
capture a vehicle periphery to generate the captured images, and detect vehicle information including position information of the vehicle at a time of image capture.

11. An information processing method being performed by a first processor, the information processing method comprising:
acquiring captured images that have been captured by a plurality of vehicles, each of the captured images satisfying a plurality of predetermined conditions including an image capture freshness condition, an image capture condition, and a moving body condition relating to a moving body in the captured image, and also acquiring vehicle information including position information corresponding to the respective captured images;
detecting the moving body present in one of the acquired captured images;
based on the captured images and the vehicle information, from other of the acquired captured images corresponding to an image capture position of the one captured image in which the moving body has been detected, selecting another of the captured images having a predetermined similarity level or higher to the one captured image; and
removing the detected moving body from the one captured image, extracting an image corresponding to a removed region from the selected other captured image, and merging these images.

12. The information processing method of claim 11, further comprising giving a score for the image capture freshness condition, the image capture condition, and the moving body condition, and acquiring any of the captured images for which the score is a predetermined threshold or higher.

13. The information processing method of claim 12, further comprising computing the score such that a score for the image capture freshness condition becomes higher the more recent an image capture date and time are, a score for the image capture condition becomes higher as a brightness level approaches a predetermined brightness level suited to conditions at the time of image capture and the slower a vehicle speed is, and a score for the moving body condition becomes higher the fewer pixels that are occupied by the moving body in the captured image.

14. The information processing method of claim 11, further comprising performing acquisition a predetermined number of times within a predetermined time period.

15. The information processing method of claim 12, further comprising changing the threshold and acquiring the captured images so as to perform acquisition a predetermined number of times within a predetermined time period.

16. A non-transitory storage medium storing a program executable by a first processor to execute information processing, the information processing comprising:
acquiring captured images that have been captured by a plurality of vehicles, each of the captured images satisfying a plurality of predetermined conditions including an image capture freshness condition, an image capture condition, and a moving body condition relating to a moving body in the captured image, and also acquiring vehicle information including position information corresponding to the respective captured images;
detecting the moving body present in one of the acquired captured images;
based on the captured images and the vehicle information, from other of the acquired captured images corresponding to an image capture position of the one captured image in which the moving body has been detected, selecting another of the captured images having a predetermined similarity level or higher to the one captured image; and
removing the detected moving body from the one captured image, extracting an image corresponding to a removed region from the selected other captured image, and merging these images.

17. The non-transitory storage medium of claim 16, wherein the processing further comprises giving a score for the image capture freshness condition, the image capture condition, and the moving body condition, and acquiring any of the captured images for which the score is a predetermined threshold or higher.

18. The non-transitory storage medium of claim 17, wherein the processing further comprises computing the score such that a score for the image capture freshness condition becomes higher the more recent an image capture date and time are, a score for the image capture condition becomes higher as a brightness level approaches a predetermined brightness level suited to conditions at the time of image capture and the slower a vehicle speed is, and a score for the moving body condition becomes higher the fewer pixels that are occupied by the moving body in the captured image.

19. The non-transitory storage medium of claim 16, wherein the processing further comprises performing acquisition a predetermined number of times within a predetermined time period.

20. The non-transitory storage medium of 17, wherein the processing further comprises changing the threshold and acquiring the captured images so as to perform acquisition a predetermined number of times within a predetermined time period.
